(19) United States
(12) Patent Application Publication
(10) Pub. No.: US 2021/0237698 A1
(43) Pub. Date: Aug. 5, 2021

(54) REDUNDANT BRAKING SYSTEM FOR A MOTOR VEHICLE

(71) Applicant: NIO USA, Inc., San Jose, CA (US)

(72) Inventors: Aaron R. Bailey, Mountain View, CA (US); Bruno M. Barthelemy, Los Gatos, CA (US); Jorge A. Marquez Sanchez, Cupertino, CA (US)

(21) Appl. No.: 16/781,539

(22) Filed: Feb. 4, 2020

(51) Int. Cl. B60T 8/17; B60T 7/04; B60T 13/66; B60T 8/32; B60T 7/12

(52) U.S. Cl. CPC B60T 8/17; B60T 7/042; B60T 13/662; B60T 8/326; B60T 7/12; B60T 2270/82; B60T 2270/403; B60T 2270/413; B60T 2270/88; B60T 2270/404; B60T 2270/402

(57) ABSTRACT

A brake system for a vehicle comprises a braking control unit comprising a first electronic control unit (ECU), a second ECU, and an actuator in communication with the first ECU and the second ECU. The ECUs each receive identical braking signals. On receiving a braking signal, the first ECU causes an actuator to activate a plunger to apply pressure to brake fluid in a hydraulic braking system, causing friction brakes to decelerate road wheels. The second ECU is configured to determine whether the first ECU is in a failure state. If the first ECU is in a failure state, the second ECU causes the actuator to activate a plunger to apply pressure to brake fluid in a hydraulic braking system, causing friction brakes to decelerate road wheels. The actuator and ECUs are disposed within a single unit.

### FIELD

The present disclosure is generally directed to a pedal assembly for a motor vehicle.

### BACKGROUND

Motor vehicles, including cars, trucks, and buses, often include pedals positioned in front of a driver's seat. Such pedals include an accelerator or gas pedal, a brake pedal, and, in vehicles with manual transmission systems, a clutch pedal. Traditionally, such pedals have been mechanically connected to components of the vehicle such that depressing the pedal initiates a mechanical response in the vehicle system. For example, depressing an accelerator may open a throttle valve. Depressing a brake pedal may cause frictional brake pads to contact road wheels. Depressing a clutch pedal may disengage a clutch system to allow for gear shifting.

Many modern vehicles use “wire” systems rather than mechanical systems. In wire systems, depressing a pedal does not cause mechanical operation of vehicle components through mechanical connections, but instead creates an electronic signal or other type of signal that causes a processor to cause actuators to control corresponding vehicle components. Because braking in such systems is controlled by electronic rather than mechanical means, there is a risk of communication failure preventing braking commands from being executed.

Accordingly, it is an object of the present invention to provide a braking system with a redundant control mechanism that executes braking commands in the event of a failure state in the primary control mechanism.

### BRIEF DESCRIPTION OF THE DRAWINGS

FIG. 1 shows a braking system in accordance with embodiments of the present disclosure;

FIG. 2 shows a braking system in accordance with embodiments of the present disclosure;

FIG. 3 shows the operation of an electronic control unit in accordance with embodiments of the present disclosure;

FIG. 4 shows the operation of an electronic control unit in accordance with embodiments of the present disclosure;

FIG. 5 shows the operation of an electronic control unit in accordance with embodiments of the present disclosure; and

FIG. 6 shows an actuator in accordance with embodiments of the present disclosure.

### DETAILED DESCRIPTION

Embodiments of the present disclosure will be described in connection with a vehicle, and more particularly with respect to an automobile. However, for the avoidance of doubt, the present disclosure encompasses the use of the aspects described herein in vehicles other than automobiles. Further, embodiments of the present disclosure will be described in connection with drive by wire systems. However, for the avoidance of doubt, the present disclosure encompasses the use of aspects described herein in non-drive by wire systems.

Drive by wire technology uses electrical or electro-mechanical systems to control vehicle components traditionally performed by mechanical connections. Drive by wire systems employ actuators and modified forms of traditional mechanical user input devices such as steering wheels and pedals. Components such as the steering column, shafts, pumps, hoses, belts, coolers and vacuum servos and master cylinders may be eliminated from the vehicle. Examples of drive by wire systems include electronic throttle control and brake-by-wire systems, which may be used together.

There are several advantages of drive by wire systems. First, an electronic throttle is significantly lighter in weight than a traditional mechanical throttle system, improving fuel efficiency. Drive by wire systems are also easier to maintain, as maintenance may be performed by a computer interface rather than mechanical operations. Electronic control also allows for more precision in controlling various operations of the vehicle compared to mechanical components which may wear, stretch, or otherwise degrade due to age and/or use. This significantly enhances the safety and performance of drive by wire vehicles compared to mechanical vehicles. Vehicle operations can also be finely programmed by automotive manufacturers or maintenance personnel, rather than relying on less predictable mechanical components.

Further, because operator controls are not limited by mechanics, controls can be fine-tined to user preferences, including ergonomic preferences.

Examples of drive by wire systems that may employ pedals include electronic throttle control, brake by wire, and shift by wire. In electronic throttle control, a wired accelerator pedal replaces a traditional mechanical accelerator pedal. In brake by wire, a wired brake pedal replaces a traditional mechanical brake pedal. In shift by wire, both the traditional mechanical clutch pedal and mechanical gearshift lever may be replaced by electronic components. Further, shift by wire may eliminate the need for a clutch pedal altogether, though certain users may prefer an emulated clutch pedal to replicate the feel of a traditional manual transmission system.

In an electronic throttle control system, the accelerator pedal is electronically connected to the throttle, replacing a mechanical connection. An electronic throttle system may comprise an accelerator pedal assembly; a throttle valve that can be opened and closed, for example, by an electric motor; and an electronic control module operating as a powertrain. The electronic control module may comprise a processor configured to receive signals from various vehicle sensors and calculate the proper throttle position based on sensor data. The primary sensor data for this purpose is the data supplied by the accelerator position sensors, but additional data may be used, including data related to engine speed, vehicle speed, road conditions, and obstacles.

An electronic throttle control system has the advantage of maintaining constant throttle control characteristics from the perspective of the operator regardless of vehicle conditions, road conditions, and other variables. An electronic throttle control system may also compensate for user error or other unsafe operator conduct by, for example, reducing rapid accelerations and decelerations.

Electronic throttle control also enhances the operation of existing electronic vehicle control systems such as cruise control, stability control, and collision avoidance systems, all of which require control of the speed and acceleration of the vehicle through operation of the throttle, and may require throttle operation independent of the position of the accelerator pedal.

A key feature of electronic throttle control is the lack of mechanical connection between the accelerator pedal and the throttle valve. The accelerator pedal assembly includes a sensor which transmits signals to a processor for control of actuators to control the position of the throttle, such as by an electric motor.

A brake by wire system controls vehicle brakes through electrical rather than purely mechanical and/or hydraulic means. A brake by wire system uses electronic sensors and actuators to control brakes in a manner traditionally performed by mechanical components such as pumps, hoses, fluids, belts, vacuum servos and master cylinders. Traditional operator components such as pedals are still used.

Brake by wire technology has been deployed in electric vehicles and hybrid vehicles. For example brake by wire has been used in their regenerative braking systems for electric vehicles and hybrid vehicles. Certain systems use a modified ABS (antilock brake system) actuator coupled with a hydraulic brake master cylinder to create a hydraulic system, coupled with a brake control unit. The brake control unit is a computer system that controls brake functions.

In a brake by wire system, the brake pedal apparatus comprises a sensor that measures the force generated by depressing a brake pedal. An actuator may provide pressure, such as hydraulic pressure, to the braking the system and valves to pressurize road wheel calipers to apply a friction brake in response to the brake pedal force sensor.

The primary sensor for the brake by wire system is the sensor associated with the pedal assembly that senses the position of the brake pedal. However, other sensors may provide data to control the brake system. These sensors include wheel speed sensors, traction sensors, battery charge sensors, positional sensors, steering wheel position sensors, and the positions of other pedals.

In addition to hydraulic braking systems, which are typical on passenger vehicles, brake by wire systems may be used with compressed air braking systems, such as those used on heavy duty commercial vehicles.

In a typical operation of a brake by wire system, once the operator inputs a brake command to the system by depressing a brake pedal, a sensor associated with the brake pedal assembly generates signals which are transmitted to the electronic control unit via an onboard communications system. The electronic control unit then generates brake commands, which are sent to four electric calipers via the communication network. It will be understood that redundant communication paths would be useful to ensure that brake commands reach the calipers.

Each caliper comprises a controller that receives the brake commands. Each controller in turn provides drive control commands to a power control module. Each power control module supplies controlled current to an associated brake actuator. Each brake actuator may be, for example, a magnetic motor or other type of motor. Each brake actuator, in turn, controls the application of friction brakes to respective road wheels in response to brake commands.

Because brake by wire systems rely on electronic connections and communications rather than mechanical connections, there is a risk of communication failure or other types of system failures that may prevent a brake command from being executed. This creates serious risk to the safety of the operator, passengers, pedestrians, and other vehicles, as well as risks of property damage from vehicles unable to stop or slow down.

Various redundancies have been developed in braking system to reduce the risk associated with brake command failure. Typically, a “back up” mechanism is provided in a braking system to execute brake commands in the event the primary system fails. The present disclosure includes a compact solution providing a redundant power brake unit.

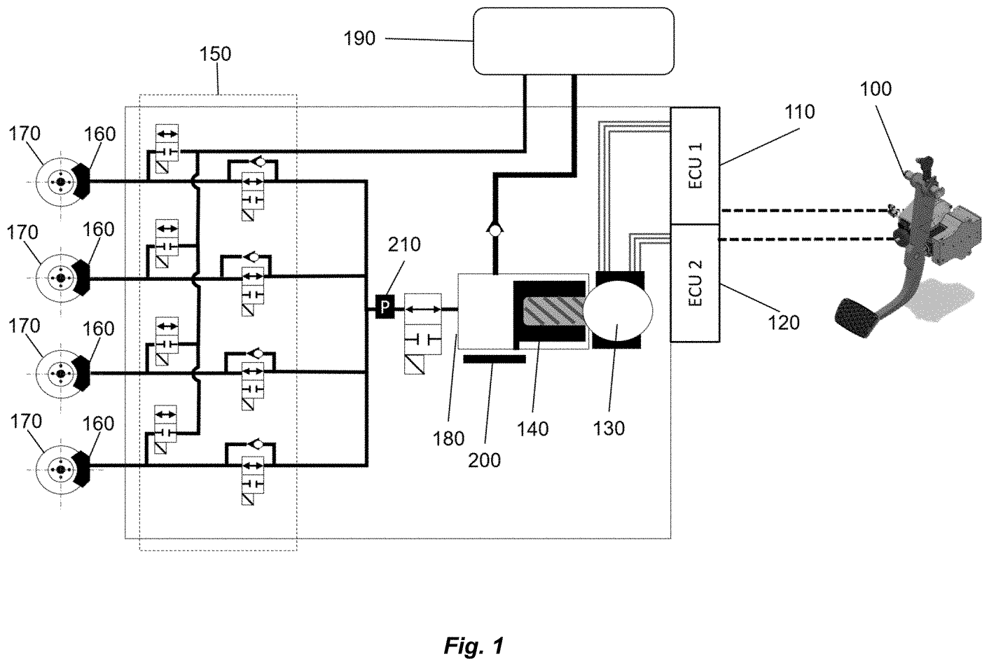

FIG. 1 shows a braking control system according to embodiments of the present disclosure. A brake pedal assembly 100 transmits identical braking signals to a first electronic control unit (“ECU 1”) 110 and a second electronic control unit (“ECU 2”) 120. Each ECU is in electrical communication with a single actuator 130. On receiving a brake command from ECU1, the actuator 130 causes a plunger 140 to force brake fluid into a hydraulic braking system 150. The hydraulic fluid exerts pressure on friction brakes 160, causing them to decelerate road wheels 170. Once the brake command is removed (e.g., the pedal arm of the pedal assembly is no longer depressed), the actuator 130 retracts and the plunger chamber 180 is refilled with brake fluid from brake fluid reservoir 190.

The system further comprises a position sensor 200 that detects the position of the plunger 140. Optionally, the position sensor 200 provides position data to ECU 2.

The system further comprises a pressure sensor 210 that detects brake fluid pressure. Optionally, the pressure sensor 210 provides pressure data to ECU 2.

In normal operation, ECU 1 controls actuator 130 and the braking signal received by ECU 2 is discarded. However, when ECU 1 is in a failure state and does not activate the actuator in response to the brake command, ECU 2 is configured to independently control actuator 130.

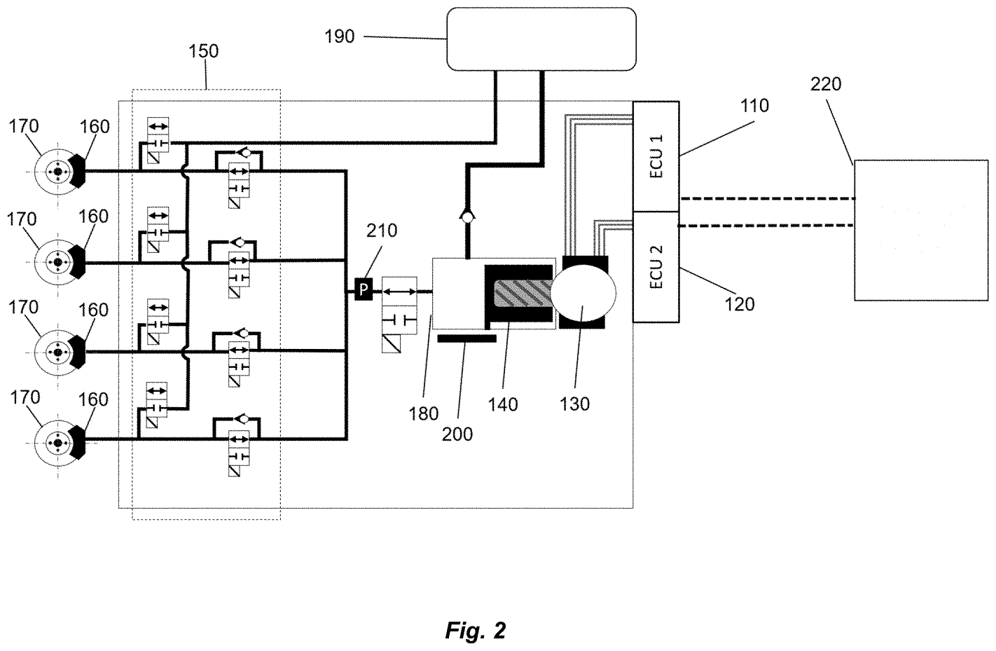

FIG. 2 shows a braking control system according to embodiments of the present disclosure. FIG. 2 is identical to FIG. 1 except that an autonomous driving controller 220, rather than a brake pedal assembly, provides brake commands to ECU 1 and ECU 2.

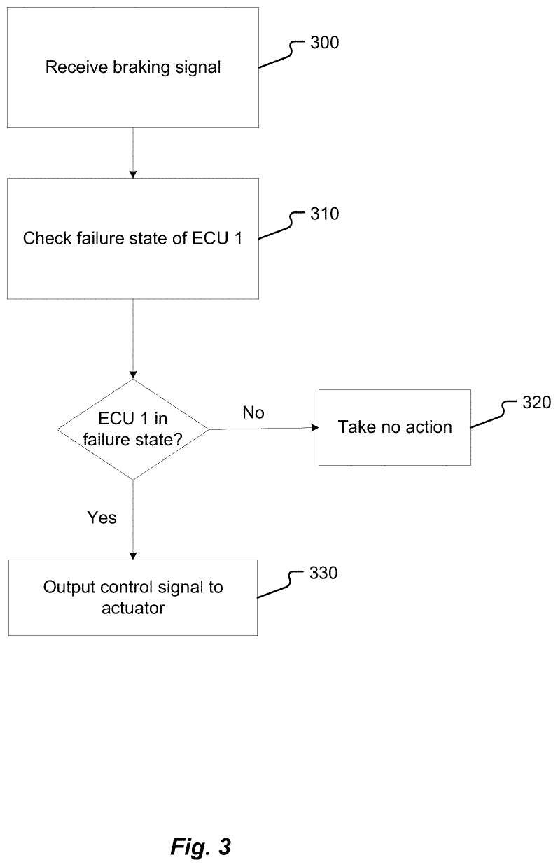

FIG. 3 illustrates the operation of ECU 2 according to embodiments of the present disclosure. At Step 300, ECU 2 receives a braking signal, e.g. from a brake pedal assembly or autonomous driving controller. At Step 310, ECU 2 checks the failure state of ECU 1. If ECU 1 is not in a failure state, ECU 2 proceeds to step 320, discards the braking signal, and takes no action. If ECU 1 is in a failure state, ECU 2 proceeds to step 330 and outputs a control signal to actuator 130.

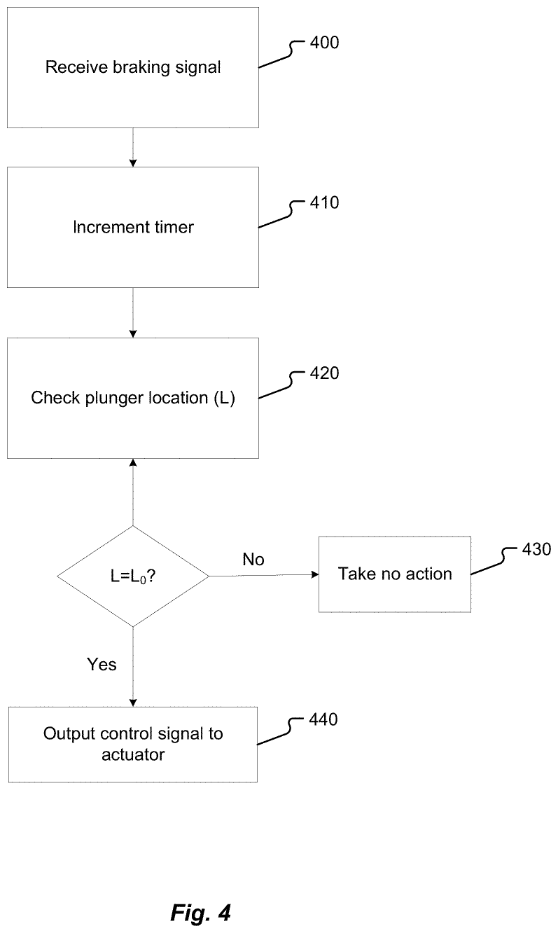

FIG. 4 illustrates the operation of ECU 2 according to embodiments of the present disclosure. In this embodiment, ECU 2 is configured with a resting plunger location value L₀. At Step 400, ECU 2 receives a braking signal, e.g. from a brake pedal assembly or autonomous driving controller. At Step 410, ECU 2 increments a timer. At step 420, ECU 2 checks the plunger location L, e.g. by receiving plunger location data from position sensor 200. Because the timer has been incremented, if ECU 1 has output a control signal, plunger location L should be different from resting location value L₀. Thus, at step 420, ECU 2 compares the measured location value L to resting location value L₀. If L is not equal to L₀, the plunger has moved, and thus ECU 1 has output a control signal to actuator 130, and ECU 1 is not in a failure state. Thus, if L is not equal to L₀, ECU 2 proceeds to step 430, discards the braking signal, and takes no action. If L=L₀, the plunger has not moved, ECU 1 has not output a control signal to actuator 130, and ECU 1 is in a failure state. Thus, if L=L₀, ECU 2 proceeds to step 440 and outputs a control signal to actuator 130.

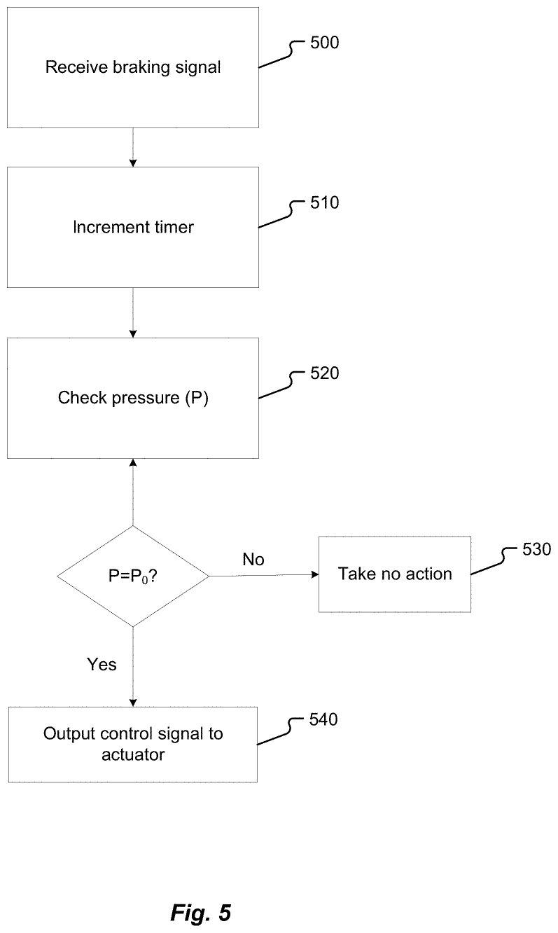

FIG. 5 illustrates the operation of ECU 2 according to embodiments of the present disclosure. In this embodiment, ECU 2 is configured with a resting brake fluid pressure value P₀. At Step 500, ECU 2 receives a braking signal, e.g. from a brake pedal assembly or autonomous driving controller. At Step 510, ECU 2 increments a timer. At step 520, ECU 2 checks the brake fluid pressure P, e.g. by receiving pressure data from pressure sensor 210. Because the timer has been incremented, if ECU 1 has output a control signal, brake fluid pressure P should be different from resting brake fluid pressure P₀. Thus, at step 520, ECU 2 compares the measured brake fluid pressure P to resting brake fluid pressure P₀. If P is not equal to P₀, the plunger has increased the brake fluid pressure, and thus ECU 1 has output a control signal to actuator 130, and ECU 1 is not in a failure state. Thus, if P is not equal to P₀, ECU 2 proceeds to step 530, discards the braking signal, and takes no action. If P=P₀, the plunger has not increased the brake fluid pressure, ECU 1 has not output a control signal to actuator 130, and ECU 1 is in a failure state. Thus, if P=P₀, ECU 2 proceeds to step 540 and outputs a control signal to actuator 130.

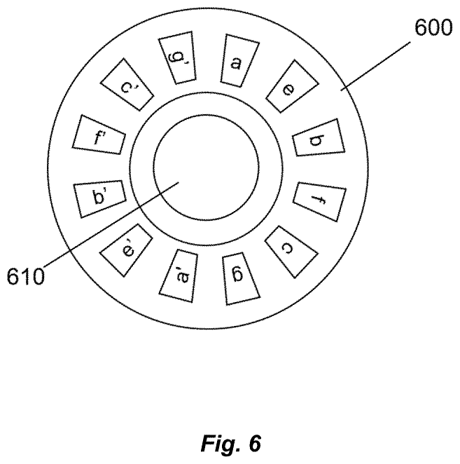

FIG. 6 illustrates an actuator 130 according to embodiments of the present disclosure. In a preferred embodiment, actuator 130 is a six-phase motor split into to three-phase groups a, b, c and e, f, g. The three phases of each group share a common node, but the two groups are each independently controlled by a separate ECU. For example, ECU 1 may control phases a, b and c; ECU 2 may control phases e, f and g. Each group is connected to an independent 3-phase inverter and operates as an independent motor. However, the two groups together form a single motor apparatus, thereby enhancing the compactness and redundancy of the system.

In a conventional three-phase motor, three wires coiled within an armature provide alternating voltages having the same frequency and amplitude but phase-shifted with respect to each other. The phased voltages across the wires create a rotating magnetic field inside the armature. The rotating magnetic field causes a motor shaft disposed within the armature to rotate. This rotation can be used, e.g., to actuate a plunger in a braking system.

In the six-phase motor disclosed herein, the wires associated with each three-phrase group are interleaved about the circumference of the armature 600. The wire coiling begins in the a-slot and then proceeds to the opposite slot, a′, and then to the common node of the first three-phase group. The wiring continues with the b-slot, b′-slot, c-slot, and c′-slot. Once the a, b and phases are wired, a three-phase motor has been constructed, and applying phased alternating currents through these wires will create a rotating magnetic field that will cause motor shaft 610 to rotate. However, the e-slot, e′-slot, f-slot, f′-slot, g-slot, and g′-slot can be wired in the same way with a second node. In this way, two separate three-phase motors, each independently controlled by a separate ECU, can be constructed in the space of a single motor component.

In operation, ECU 1 receives a braking signal and activates the a-b-c phase group, creating the magnetic field that causes the motor shaft 610 to rotate and activate the plunger. If ECU 1 is in a failure state, ECU 2 activates the e-f-g phase group, creating the magnetic field that causes the motor shaft to rotate and activate the plunger.

An advantage of the present disclosure is that at least the actuator 130, ECU 1 and ECU 2 are disposed within a single braking control unit, such as a metal container or other suitable container, thereby enhancing compactness.

The features of the various embodiments described herein are not intended to be mutually exclusive. Instead, features and aspects of one embodiment may be combined with features or aspects of another embodiment. Additionally, the description of a particular element with respect to one embodiment may apply to the use of that particular element in another embodiment, regardless of whether the description is repeated in connection with the use of the particular element in the other embodiment.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The systems and methods of this disclosure have been described in relation to the braking mechanism(s) for a vehicle. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Embodiments include a brake system for a vehicle comprising: a braking control unit comprising: a first electronic control unit; a second electronic control unit; an actuator in communication with said first electronic control unit and said second electronic control unit; a plurality of brakes mechanically linked to said actuator via a plurality of said mechanical linking members; a pedal assembly in operative communication with said first electronic control unit and said second electronic control unit; wherein said first electronic control unit is configured to control said actuator independently of said second electronic control unit, and said second electronic control unit is configured to control said actuator independently of said first electronic control unit; and wherein said second electronic control unit is configured to control said actuator in response to a signal indicating that said first electronic control unit is in a failure state.

Aspects of the above brake system include: said plurality of brakes is mechanically linked to said actuator by hydraulic means; said braking control unit further comprises a pressure sensor configured to sense hydraulic pressure; said braking control unit further comprises a plunger mechanically linked to said actuator; said braking control unit further comprises a position sensor associated with said plunger; at least one of said electronic control units further comprises a coolant sensor; at least one of said electronic control units is configured to receive a signal indicating the position of a brake pedal.

Embodiments include a brake system for a vehicle comprising: a braking control unit comprising: a first electronic control unit; a second electronic control unit; an actuator engaged with said first and second electronic control units; one or more brakes in operative engagement with said actuator; an autonomous driving controller in communication with said first electronic control unit and said second electronic control unit; wherein said first electronic control unit controls said actuator in a first mode, and said second electronic control unit controls said actuator in a different second mode; and wherein, in the second mode, said second electronic control unit controls said actuator in response to a signal indicating that said first electronic control unit is in a failure state.

Aspects of the above brake system include: in the first mode, the second electronic control unit does not control the actuator, wherein, in the second mode, the first electronic control unit does not control the actuator, and wherein said one or more brakes is mechanically linked to said actuator by hydraulic means; said braking control unit further comprises a pressure sensor configured to sense hydraulic pressure; said braking control unit further comprises a plunger mechanically linked to said actuator; said braking control unit further comprises a position sensor associated with said plunger; at least one of said electronic control units further comprises a coolant sensor; at least one of said electronic control units is configured to receive braking signals from said autonomous driving controller.

Embodiments include a method of braking a vehicle, comprising: transmitting a braking signal to at least one of a first electronic control unit and to a second electronic control unit; said braking signal causing said at least one of said first electronic control unit and said second electronic control unit to control an actuator in communication with said first electronic control unit and said second electronic control unit; said actuator causing a one or more brakes to inhibit movement of said vehicle, said one or more brakes being mechanically linked to said actuator; wherein said first electronic control unit controls the actuator independently of said second electronic control unit, and said second electronic control unit controls the actuator independently of said first electronic control unit; wherein said second electronic control unit controls said actuator in response to a signal indicating that said first electronic control unit is in a failure state; and wherein said first electronic control unit, said second electronic control unit, and said actuator are disposed with a braking control unit.

Aspects of the above method include: said plurality of brakes is mechanically linked to said actuator by hydraulic means; causing a plunger mechanically linked to said actuator within said braking control unit to apply hydraulic pressure to said plurality of brakes; causing a position sensor associated with said plunger within said braking control unit to sense the position of said plunger; said step of transmitting a braking signal comprises depressing a brake pedal; said braking signal is transmitted from an autonomous driving controller.

Embodiments include any one or more of the aspects/embodiments as substantially disclosed herein optionally in combination with any one or more other aspects/embodiments as substantially disclosed herein.

Embodiments include one or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A brake system for a vehicle comprising:
a braking control unit comprising:
a first electronic control unit;
a second electronic control unit; and
an actuator in communication with said first electronic control unit and said second electronic control unit;
a plurality of brakes mechanically linked to said actuator via a plurality of said mechanical linking members;
a pedal assembly in operative communication with said first electronic control unit and said second electronic control unit;
wherein said first electronic control unit is configured to control said actuator independently of said second electronic control unit, and said second electronic control unit is configured to control said actuator independently of said first electronic control unit; and
wherein said second electronic control unit is configured to control said actuator in response to a signal indicating that said first electronic control unit is in a failure state.

2. The brake system of claim 1, wherein said plurality of brakes is mechanically linked to said actuator by hydraulic means.

3. The brake system of claim 2, wherein said braking control unit further comprises a pressure sensor configured to sense hydraulic pressure.

4. The brake system of claim 2, wherein said braking control unit further comprises a plunger mechanically linked to said actuator.

5. The brake system of claim 4, wherein said braking control unit further comprises a position sensor associated with said plunger.

6. The brake system of claim 1, wherein at least one of said electronic control units further comprises a coolant sensor.

7. The brake system of claim 1, wherein at least one of said electronic control units is configured to receive a signal indicating the position of a brake pedal.

8. A brake system for a vehicle comprising:
a braking control unit comprising:
a first electronic control unit;
a second electronic control unit; and
an actuator engaged with said first and second electronic control units;
one or more brakes in operative engagement with said actuator;
an autonomous driving controller in communication with said first electronic control unit and said second electronic control unit;
wherein said first electronic control unit controls said actuator in a first mode, and said second electronic control unit controls said actuator in a different second mode; and
wherein, in the second mode, said second electronic control unit controls said actuator in response to a signal indicating that said first electronic control unit is in a failure state.

9. The brake system of claim 8, wherein, in the first mode, the second electronic control unit does not control the actuator, wherein, in the second mode, the first electronic control unit does not control the actuator, and wherein said one or more brakes is mechanically linked to said actuator by hydraulic means.

10. The brake system of claim 9, wherein said braking control unit further comprises a pressure sensor configured to sense hydraulic pressure.

11. The brake system of claim 9, wherein said braking control unit further comprises a plunger mechanically linked to said actuator.

12. The brake system of claim 11, wherein said braking control unit further comprises a position sensor associated with said plunger.

13. The brake system of claim 8, wherein at least one of said electronic control units further comprises a coolant sensor.

14. The brake system of claim 8, wherein at least one of said electronic control units is configured to receive braking signals from said autonomous driving controller.

15. A method of braking a vehicle, comprising:
transmitting a braking signal to at least one of a first electronic control unit and to a second electronic control unit;
said braking signal causing said at least one of said first electronic control unit and said second electronic control unit to control an actuator in communication with said first electronic control unit and said second electronic control unit;
said actuator causing a one or more brakes to inhibit movement of said vehicle, said one or more brakes being mechanically linked to said actuator;
wherein said first electronic control unit controls the actuator independently of said second electronic control unit, and said second electronic control unit controls the actuator independently of said first electronic control unit;
wherein said second electronic control unit controls said actuator in response to a signal indicating that said first electronic control unit is in a failure state; and
wherein said first electronic control unit, said second electronic control unit, and said actuator are disposed with a braking control unit.

16. The method of claim 15, wherein said plurality of brakes is mechanically linked to said actuator by hydraulic means.

17. The method of claim 16, further comprising causing a plunger mechanically linked to said actuator within said braking control unit to apply hydraulic pressure to said plurality of brakes.

18. The brake system of claim 17, further comprising causing a position sensor associated with said plunger within said braking control unit to sense the position of said plunger.

19. The method of claim 15, wherein said step of transmitting a braking signal comprises depressing a brake pedal.

20. The method of claim 15, wherein said braking signal is transmitted from an autonomous driving controller.
